(19) United States
(12) Patent Application Publication
(10) Pub. No.: US 2012/0242797 A1
(43) Pub. Date: Sep. 27, 2012

(54) VIDEO DISPLAYING APPARATUS AND VIDEO DISPLAYING METHOD

(75) Inventor: Kiyomi WATANABE, Fukaya-shi (JP)

(73) Assignee: KABUSHIKI KAISHA TOSHIBA, Tokyo (JP)

(21) Appl. No.: 13/299,607

(22) Filed: Nov. 18, 2011

(30) Foreign Application Priority Data
Mar. 25, 2011 (JP) 2011-068673

(51) Int. Cl. H04N 13/02; H04N 13/04

(52) U.S. Cl. 348/46; 348/E13.074; 348/E13.075

(57) ABSTRACT

According to one embodiment, a video displaying apparatus includes a separator, a generator and a controller. The separator is configured to separate a video signal for 3D video display into first and second video signals. The generator is configured to generate a first video frame in which a frame of the first video signal is displayed in a first area on a screen, to generate a second video frame in which a frame of the first or second video signal is displayed in a second area different from the first area, to generate a third video frame similar to the first video frame, and to generate a fourth video frame in which a frame of the second or first video signal is displayed in the second area. The controller is configured to sequentially display the first to fourth video frames in this order.

### CROSS-REFERENCE TO RELATED APPLICATIONS

This application is based upon and claims the benefit of priority from prior Japanese Patent Application No. 2011-068673, filed Mar. 25, 2011, the entire contents of which are incorporated herein by reference.

### FIELD

Embodiments described herein relate generally to a video displaying apparatus and a video displaying method for 3D (stereoscopic) video display by use of a planar video display screen.

### BACKGROUND

As is well known, there has been developed a technique for causing a user to recognize stereoscopic video by use of a planar video display screen. With this technique, two kinds of video having a parallax therebetween corresponding to an interval between human eyes are prepared to cause the user's right eye to recognize right-eye video and the user's left eye to recognize left-eye video, thereby performing 3D video display.

Specifically, there exists a technique for causing the user to recognize 3D video by alternately displaying the right- and left-eye video on the same video display screen and controlling such that a left-eye shutter is closed while the right-eye video is being displayed and a right-eye shutter is closed while the left-eye video is being displayed for stereoscopic viewing glasses the user wears.

It is known that the 3D video displayed on the planar video display screen can adversely affect viewer's vision, and that particularly when a developing person such as a child views the 3D video for a long time, normal visual development can be impaired.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an outer profile view for explaining an exemplary digital television broadcast receiver according to an embodiment;

FIG. 2 is a block structure diagram for explaining an exemplary signal processing system of the digital television broadcast receiver according to the embodiment;

FIG. 3 is an outer profile view for explaining an exemplary remote controller configured to operate the digital television broadcast receiver according to the embodiment;

FIG. 4 is a diagram for explaining an exemplary 2D/3D simultaneous display mode setting screen displayed on the digital television broadcast receiver according to the embodiment;

FIG. 5 is a diagram for explaining an exemplary 2D/3D simultaneous display screen displayed on the digital television broadcast receiver according to the embodiment;

FIG. 6 is a block structure diagram for explaining an exemplary 2D/3D simultaneous display processor incorporated in a video processor of the digital television broadcast receiver according to the embodiment;

FIG. 7 is a diagram for explaining an exemplary operation of a right/left video separator configuring the 2D/3D simultaneous display processor according to the embodiment;

FIGS. 8A, 8B and 8C are diagrams for explaining exemplary main operations performed by the 2D/3D simultaneous display processor on the display screen according to the embodiment, respectively; and

FIG. 9 is a flowchart for explaining exemplary main operations performed by the 2D/3D simultaneous display processor according to the embodiment.

### DETAILED DESCRIPTION

Various embodiments will be described hereinafter with reference to the accompanying drawings. In general, according to one embodiment, a video displaying apparatus comprises a separator, first to fourth generators and a controller. The separator is configured to separate a video signal for 3D video display into a first video signal and a second video signal both of which have a parallax therebetween in units of frame. The first generator is configured to generate a first video frame in which a frame of the first video signal separated in the separator is displayed in a first area on a video display screen. The second generator is configured to generate a second video frame in which a frame of one of the first and second video signals separated in the separator is displayed in a second area different from the first area on the video display screen. The third generator is configured to generate a third video frame similar to the first video frame generated in the first generator. The fourth generator is configured to generate a fourth video frame in which a frame of the other of the first and second video signals separated in the separator is displayed in the second area on the video display screen. The controller is configured to sequentially display the first to fourth video frames generated in the first to fourth generators on the video display screen in this order.

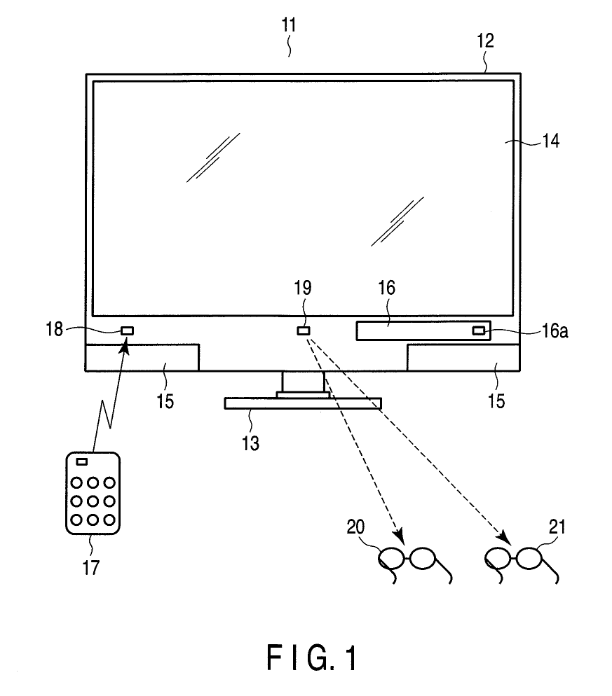

FIG. 1 shows an outer profile of a digital television broadcast receiver 11 having a 3D video display function explained in the embodiment. The digital television broadcast receiver 11 is configured of a thin cabinet 12, and a support table 13 configured to support the cabinet 12.

A video display panel 14 as a video display module is arranged on the center front of the cabinet 12. The cabinet 12 is provided with speakers 15, 15 at both ends of the lower front, which are capable of audio reproduction such as stereo sound or bilingual format.

The cabinet 12 includes, at the lower front, an operation module 16 including a power switch 16a, and a light receiver 18 configured to receive operation information transmitted from a remote controller 17. The support table 13 is rotatably connected to the center bottom of the cabinet 12, and is configured to support the cabinet 12 in a standing position while being placed on a predetermined horizontal surface (not shown).

When receiving a video signal broadcasted for 3D video display, the digital television broadcast receiver 11 generates a right-eye video signal and a left-eye video signal both of which have a parallax therebetween based on the received video signal, respectively, and alternately displays the generated right- and left-eye video on the video display panel 14.

The digital television broadcast receiver 11 generates shutter control signals for indicating a period in which the right-eye video is being displayed and a period in which the left-eye video is being displayed, respectively, and transmits them from an infrared emitter 19. The shutter control signals transmitted from the infrared emitter 19 are received by a plurality of (two in the figure) pairs of stereoscopic viewing glasses 20, 21.

The stereoscopic viewing glasses 20, 21 are controlled based on the shutter control signals transmitted from the infrared emitter 19 such that the left-eye shutter is closed during the right-eye video display period and the right-eye shutter is closed during the left-eye video display period, thereby causing the (two in this case) users wearing the stereoscopic viewing glasses 20, 21 to recognize the 3D video.

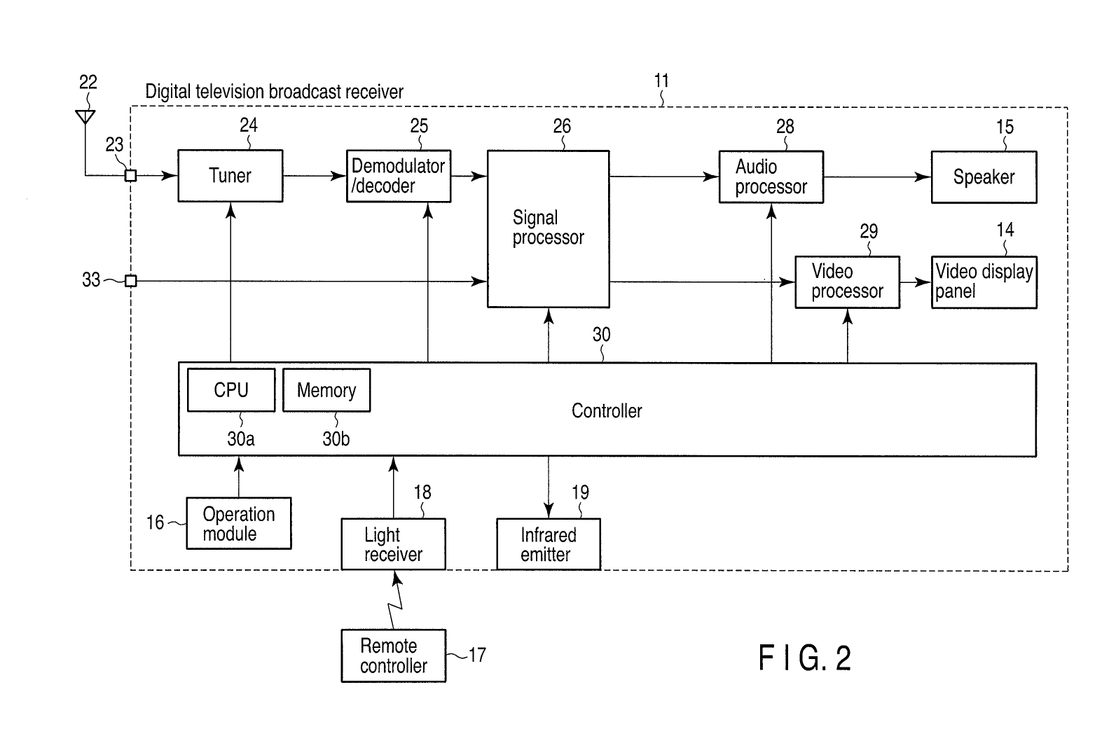

FIG. 2 schematically shows a signal processing system of the digital television broadcast receiver 11. In other words, a digital television broadcast signal received at an antenna 22 is supplied to a tuner 24 via an input terminal 23 so that a desired channel broadcast signal is selected.

The broadcast signal selected in the tuner 24 is supplied to a demodulator/decoder 25 and recovered to a digital video signal and a digital audio signal, which are output to a signal processor 26. The signal processor 26 performs predetermined digital signal processing on the digital video signal and the digital audio signal supplied from the demodulator/decoder 25, respectively.

The predetermined digital signal processing performed by the signal processor 26 includes 2D-3D conversion processing of converting a video signal for typical 2D (planar view) display into a video signal for 3D (stereoscopic) display and 3D-2D conversion processing of converting a video signal for 3D display into a video signal for 2D display.

The digital video signal output from the signal processor 26 is supplied to a video processor 29. The video processor 29 performs a predetermined format conversion processing on the input digital video signal. The video signal output from the video processor 29 is supplied to the video display panel 14 for video display.

In other words, when the video signal supplied from the signal processor 26 is for typical 2D display, the video processor 29 performs, for example, a frame double-speed conversion processing needed for the 2D video display on the video display panel 14 on the video signal, and supplies the video signal to the video display panel 14 for video display.

When the video signal supplied from the signal processor 26 is for 3D display, the video processor 29 generates a right-eye video signal and a left-eye video signal from the video signal, respectively, and double-speed converts the video signals in units of frame and alternately supplies them to the video display panel 14 for video display.

When the video signal supplied from the signal processor 26 is for 3D display, as will be detailed later, the video processor 29 performs a 2D/3D simultaneous display processing of simultaneously displaying two screens for a 2D video and a 3D video on the video display panel 14 on the video signal, and supplies the video signal to the video display panel 14 for video display.

The digital audio signal output from the signal processor 26 is supplied to an audio processor 28. The audio processor 28 converts the input digital audio signal into an analog audio signal in a reproducible format in the speakers 15, 15. The analog audio signal output from the audio processor 28 is supplied to the speakers 15, 15 for audio reproduction.

A controller 30 collectively controls various operations including the above various receiving operations of the digital television broadcast receiver 11. The controller 30 incorporates a central processing unit (CPU) 30a therein, receives operation information from the operation module 16 or operation information transmitted from the remote controller 17 and received by the light receiver 18, and controls the respective modules for reflecting the operation contents.

In this case, the controller 30 uses a memory 30b. The memory 30b includes a read-only memory (ROM) storing therein control programs to be executed by the CPU 30a, a random access memory (RAM) providing work areas to the CPU 30a, and a nonvolatile memory storing various items of setting information and control information therein.

The digital television broadcast receiver 11 is provided with an input terminal 33 configured to directly input the digital or analog video signal and audio signal from the outside. The digital or analog video signal and audio signal input via the input terminal 33 are provided for the video display and the audio reproduction.

The controller 30 is connected with the infrared emitter 19. The infrared emitter 19 transmits the shutter control signals indicating the right-eye video display period and the left-eye video display period, respectively, which are output from the video processor 29 during the 3D video display, by use of infrared rays as a transmission medium.

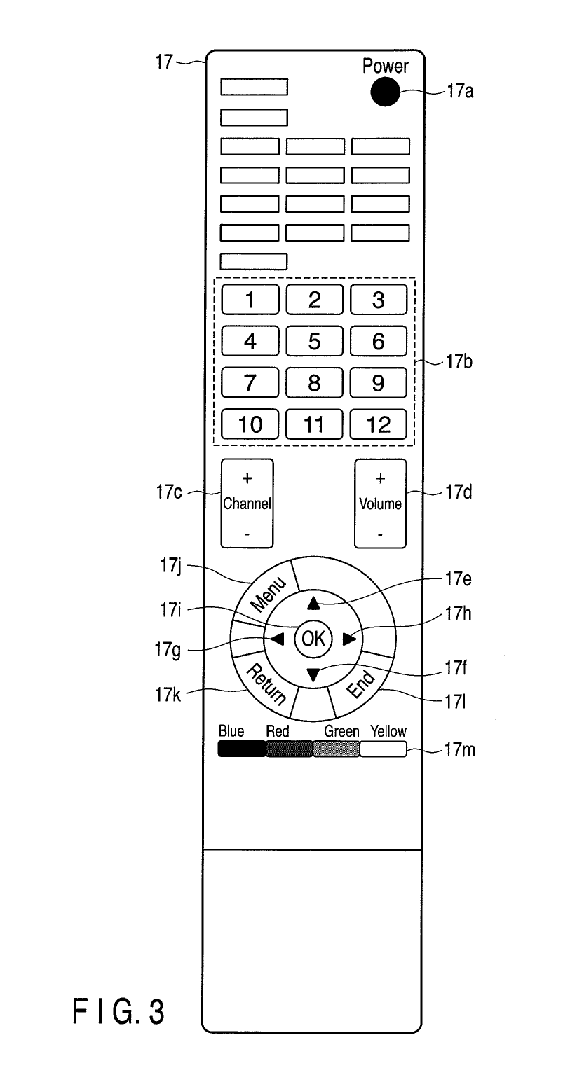

FIG. 3 shows an outer profile of the remote controller 17. The remote controller 17 is mainly provided with a power key 17a, a numeric keypad 17b, a channel up/down key 17c, a volume key 17d, a cursor up key 17e, a cursor down key 17f, a cursor left key 17g, a cursor right key 17h, an OK key 17i, a menu key 17j, a return key 17k, an end key 17l, a four-color (blue, red, green, yellow) key 17m, and the like.

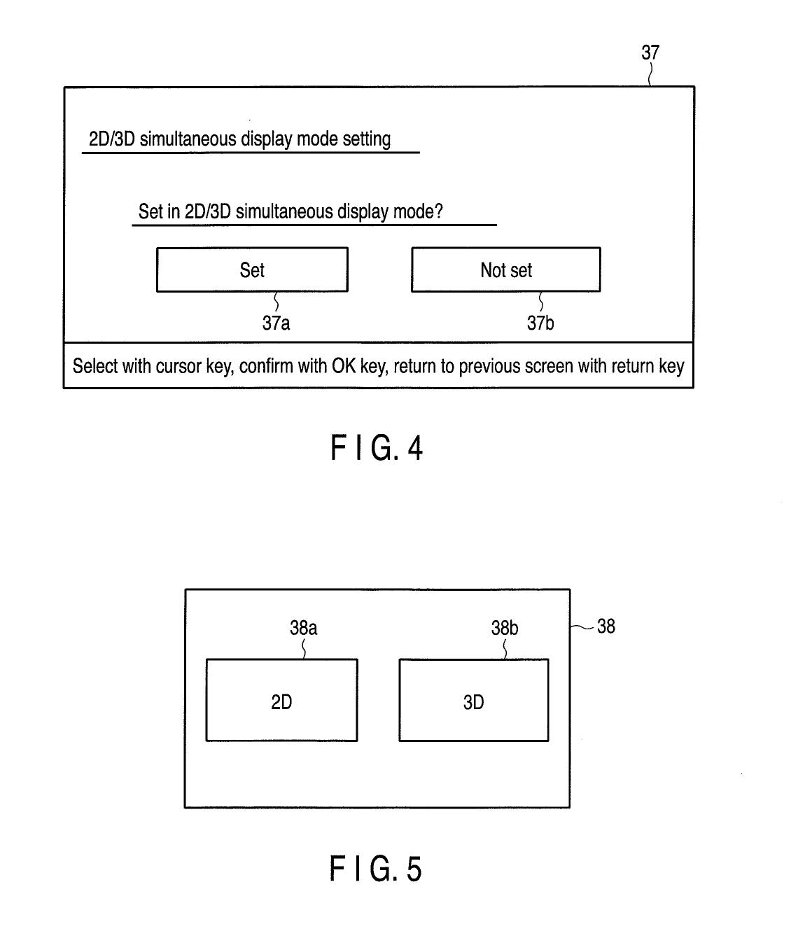

The 2D/3D simultaneous display processing in the video processor 29 will be described herein. The 2D/3D simultaneous display processing is performed by user's setting the digital television broadcast receiver 11 in the 2D/3D simultaneous display mode. The user operates the menu key 17j on the remote controller 17 to enter a plurality of menu screens in a hierarchy structure, and displays a 2D/3D simultaneous display mode setting screen 37 as shown in FIG. 4 on the video display panel 14 so that the 2D/3D simultaneous display mode is set.

In other words, the 2D/3D simultaneous display mode setting screen 37 displays thereon a question for the user of “Set 2D/3D simultaneous display mode?”, an item 37a of “set” and an item 37b of “not set.” Then, the user operates the cursor left or right key 17g or 17h on the remote controller 17 to select the item 37a, and operates the OK key 17i to set the 2D/3D simultaneous display mode.

FIG. 5 shows an exemplary 2D/3D simultaneous display screen 38 displayed on the video display panel 14 when the 2D/3D simultaneous display mode is set as described above. A first video display area 38a and a second video display area 38b are formed together on the 2D/3D simultaneous display screen 38.

The first video display area 38a displays therein the video signal for 3D display supplied to the video processor 29 as a typical 2D (planar view) video. The second video display area 38b displays therein the video signal for 3D display supplied to the video processor 29 as a 3D (stereoscopic) video. In other words, the video signal for 3D display supplied to the video processor 29 is simultaneously displayed as the 2D video and the 3D video on the screen of the video display panel 14.

The user can view the 2D video displayed in the first video display area 38a as a typical 2D video with the naked eye. The user can view the 3D video displayed in the second video display area 38b as a 3D video with stereoscopic viewing glasses 20, 21. In other words, the user can selectively view the same video as the 2D video or the 3D video.

Thus, the user can alternately view the 2D video and the 3D video simultaneously displayed on the video display panel 14 at an appropriate period with a simple operation of wearing or not wearing the stereoscopic viewing glasses 20, 21. Therefore, when the user uses the planar video display screen to view the displayed 3D video, the user can view the video whose unfavorable influence on the user's vision is remarkably prevented, which is particularly practical. Adults may view the 3D video with the stereoscopic viewing glasses 20, 21 and children may view the 2D video with the naked eye.

The first video display area 38a and the second video display area 38b can be changed in at least one of a display size and a display position on the screen of the video display panel 14 as long as they do not overlap each other. For the display size, there is used a method in which a display size setting screen is displayed on the video display panel 14 and the user selects and decides a desired size from a plurality of kinds of preset sizes. For the display position, there is used a method in which a display position setting screen is displayed on the video display panel 14 and the user selects and decides a desired display position from a plurality of kinds of preset display positions.

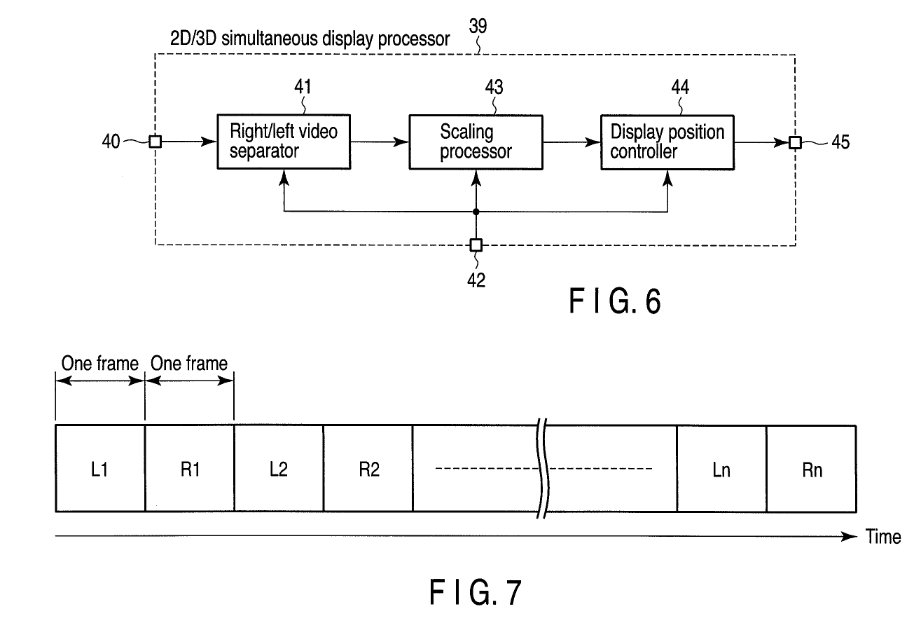

FIG. 6 shows an exemplary signal processing system of a 2D/3D simultaneous display processor 39 incorporated in the video processor 29 for the 2D/3D simultaneous display processing. In other words, an input terminal 40 is supplied with a video signal for 3D display output from the signal processor 26. The video signal for 3D display supplied to the input terminal 40 is supplied to a right/left video separator 41.

The right/left video separator 41 separates the input video signal for 3D display into a left-eye video signal and a right-eye video signal in units of frame. As shown in FIG. 7, the right/left video separator 41 alternately arranges the separated left-eye video frames L1, L2, . . . , Ln and right-eye video frames R1, R2, . . . , Rn per frame, and converts at n-times speed and outputs them in response to an instruction of the control signal supplied from the controller 30 via a control terminal 42.

The left-eye video signal and the right-eye video signal, which are output from the right/left video separator 41 in units of frame, are supplied to a scaling processor 43. The scaling processor 43 performs a scaling processing on the video signal input in units of frame for downsizing the display size of the frame to a size instructed by the control signal supplied from the controller 30 via the control terminal 42. With the scaling processing, the video signals output from the right/left video separator 41 in units of frame can be downsized to the display sizes of the first and second video display areas 38a, 38b described above.

The video signals subjected to the scaling processing by the scaling processor 43 are supplied to a display position controller 44. The display position controller 44 performs a position control processing on the video signals subjected to the scaling processing to locate the display position of the frame as instructed by the control signal supplied from the controller 30 via the control terminal 42. With the position control processing, the video signals subjected to the scaling processing can be displayed at the display positions of the first and second video display areas 38a, 38b described above.

The video signals for which the display positions are controlled by the display position controller 44 are output via an output terminal 45 and are provided for the video display on the video display panel 14. The processing operations by the 2D/3D simultaneous display processor 39 are controlled as follows based on the control signal supplied from the controller 30 via the control terminal 42.

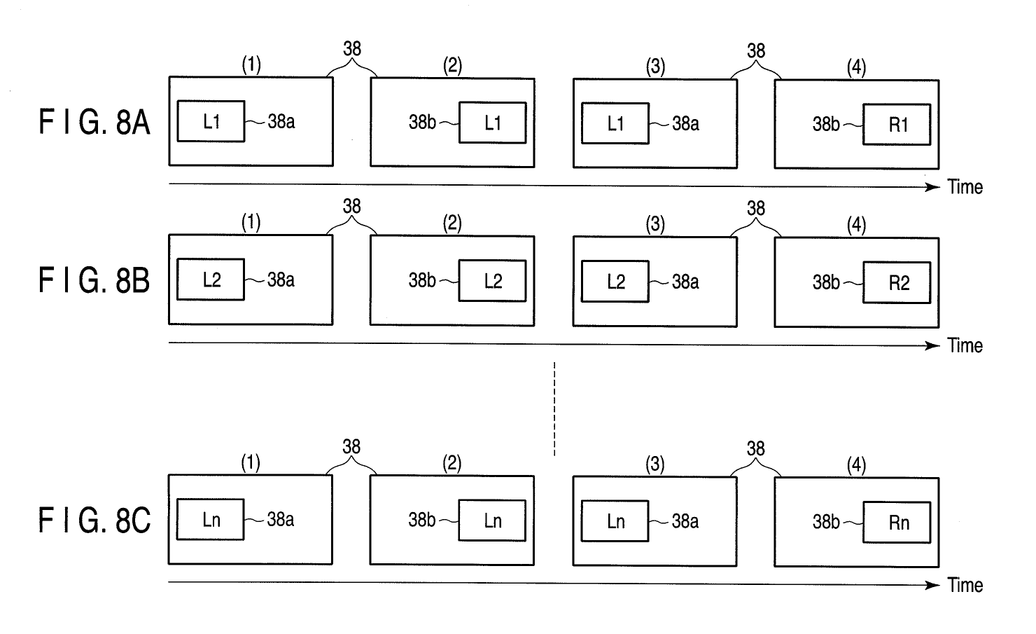

In other words, in the 2D/3D simultaneous display mode, the controller 30 controls the scaling processor 43 and the display position controller 44 such that the left-eye video frame L1 separated in the right/left video separator 41 is displayed in the first video display area 38a on the 2D/3D simultaneous display screen 38 as shown in FIG. 8A(1). In this case, the area other than the first video display area 38a on the 2D/3D simultaneous display screen 38 is displayed in black, for example.

In the next frame, the controller 30 controls the scaling processor 43 and the display position controller 44 such that the left-eye video frame L1 separated in the right/left video separator 41 is displayed in the second video display area 38b on the 2D/3D simultaneous display screen 38 as shown in FIG. 8A(2). Also in this case, the area other than the second video display area 38b on the 2D/3D simultaneous display screen 38 is displayed in black, for example.

In the next frame, the controller 30 controls the scaling processor 43 and the display position controller 44 such that the left-eye video frame L1 separated in the right/left video separator 41 is displayed in the first video display area 38a on the 2D/3D simultaneous display screen 38 as shown in FIG. 8A(3).

Furthermore, in the next frame, the controller 30 controls the scaling processor 43 and the display position controller 44 such that the right-eye video frame R1 separated in the right/left video separator 41 is displayed in the second video display area 38b on the 2D/3D simultaneous display screen 38 as shown in FIG. 8A(4).

A series of operations shown in FIGS. 8A(1), 8A(2), 8A(3) and 8A(4) described above completes an operation cycle. In this case, the left-eye video frame L1 is displayed twice across the black screen in the first video display area 38a on the 2D/3D simultaneous display screen 38, and the left-eye video frame L1 and the right-eye video frame R1 are each displayed once across the black screen in the second video display area 38b.

In other words, the 2D video by only the left-eye video frame L1 is displayed in the first video display area 38a, and the 3D video by the left-eye video frame L1 and the right-eye video frame R1 is displayed in the second video display area 38b. The black screen is inserted between the left-eye video frame L1 and the right-eye video frame R1, which is effective for reducing 3D crosstalk.

In the next frame, the left-eye video frame L2 is displayed in the first video display area 38a as shown in FIG. 8B(1). In its next frame, the left-eye video frame L2 is displayed in the second video display area 38b as shown in FIG. 8B(2). In its next frame, the left-eye video frame L2 is displayed in the first video display area 38a as shown in FIG. 8B(3). In its next frame, the right-eye video frame R2 is displayed in the second video display area 38b as shown in FIG. 8B(4).

Similarly, when the last left-eye video frame Ln is displayed in the first video display area 38a as shown in FIG. 8C(1), in its next frame, the last left-eye video frame Ln is displayed in the second video display area 38b as shown in FIG. 8C(2), in its next frame, the last left-eye video frame Ln is displayed in the first video display area 38a as shown in FIG. 8C(3), and in its next frame, the last right-eye video frame Rn is displayed in the second video display area 38b as shown in FIG. 8C(4), thereby the 2D/3D simultaneous display processing ends.

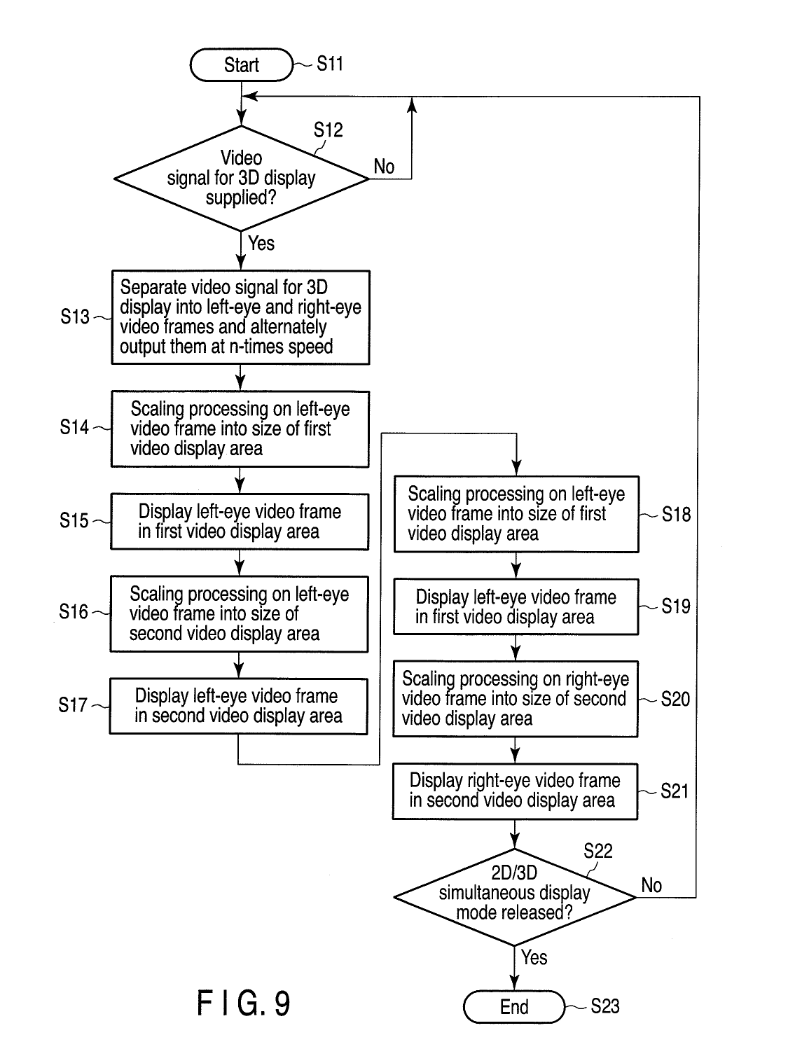

FIG. 9 is a flowchart showing the 2D/3D simultaneous display processing operations by way of example. The processing operations start when the digital television broadcast receiver 11 is set in the 2D/3D simultaneous display mode (step S11). In step S12, the controller 30 decides whether the video signal for 3D display has been supplied to the right/left video separator 41 configuring the 2D/3D simultaneous display processor 39 in the video processor 29.

When it is decided that the video signal for 3D display has been supplied to the right/left video separator 41 (YES), in step S13, the controller 30 controls such that the right/left video separator 41 separates the video signal for 3D display into the left-eye video signal and the right-eye video signal in units of frame and alternately outputs the separated left-eye video frames L and right-eye video frames R at n-times speed.

Thereafter, in step S14, the controller 30 causes the scaling processor 43 to perform the scaling processing such that the display size of the first left-eye video frame L1 corresponds to the first video display area 38a on the 2D/3D simultaneous display screen 38. In step S15, the controller 30 causes the display position controller 44 to control the display position such that the left-eye video frame L1 subjected to the scaling processing is displayed in the first video display area 38a on the 2D/3D simultaneous display screen 38. Thus, the left-eye video corresponding to the left-eye video frame L1 is displayed in the first frame (corresponding to FIG. 8A(1)) displayed in the first video display area 38a.

In step S16, the controller 30 causes the scaling processor 43 to perform the scaling processing such that the display size of the same left-eye video frame L1 corresponds to the second video display area 38b on the 2D/3D simultaneous display screen 38. In step S17, the controller 30 causes the display position controller 44 to control the display position such that the left-eye video frame L1 subjected to the scaling processing is displayed in the second video display area 38b on the 2D/3D simultaneous display screen 38. Thus, the left-eye video corresponding to the left-eye video frame L1 is displayed in the second frame (corresponding to FIG. 8A(2)) displayed in the second video display area 38b.

Then, in step S18, the controller 30 causes the scaling processor 43 to perform the scaling processing such that the display size of the same left-eye video frame L1 corresponds to the first video display area 38a on the 2D/3D simultaneous display screen 38. In step S19, the controller 30 causes the display position controller 44 to control the display position such that the left-eye video frame L1 subjected to the scaling processing is displayed in the first video display area 38a on the 2D/3D simultaneous display screen 38. Thus, the left-eye video corresponding to the left-eye video frame L1 is displayed in the third frame (corresponding to FIG. 8A(3)) displayed in the first video display area 38a. In the processing in step S18, the left-eye video frame L1 subjected to the scaling processing in step S14 may be read and used.

Next, in step S20, the controller 30 causes the scaling processor 43 to perform the scaling processing such that the display size of the right-eye video frame R1 corresponding to the same left-eye video frame L1 corresponds to the second video display area 38b on the 2D/3D simultaneous display screen 38. In step S21, the controller 30 causes the display position controller 44 to control the display position such that the right-eye video frame R1 subjected to the scaling processing is displayed in the second video display area 38b on the 2D/3D simultaneous display screen 38. Thereby, the right-eye video corresponding to the right-eye video frame R1 is displayed in the fourth frame (corresponding to FIG. 8A(4)) displayed in the second video display area 38b.

In this manner, an operation cycle shown in FIGS. 8A(1), 8A(2), 8A(3) and 8A(4) is completed. In step S22, a decision is made as to whether the 2D/3D simultaneous display mode has been released, and when it is decided that the mode is released (YES), the controller 30 terminates the processing (step S23), and when it is decided that the mode has not been released (NO), proceeds to the processing in step S12 to repeatedly perform the same processing on the subsequent left-eye video frames L2, . . . , Ln and right-eye video frames R2, . . . , Rn.

According to the embodiment, since the 2D video and the 3D video are simultaneously displayed on the video display panel 14 based on the video signal for 3D display, the user can selectively view both the videos only with a simple operation of wearing or not wearing the stereoscopic viewing glasses 20, 21. When the user views the 3D video displayed by use of the planar video display screen, the user can view the video whose unfavorable influence on the user's vision is remarkably prevented, which is particularly practical.

Since the frame displaying the 2D video in the predetermined display area and the frame displaying the 3D video in the predetermined display area are alternately displayed so that the 2D video and the 3D video are simultaneously displayed on the same screen apparently, and the 2D video and the 3D video are not displayed in the same frame in a mixed manner, various circuits needed for the mixing are not required, thereby achieving a simple structure.

It has been described that the left-eye video signal is used as the video signal for 2D display in the embodiment, but the present invention is not limited thereto and of course the right-eye video signal may be used as the video signal for 2D display.

In the embodiment, the 2D video is displayed in the first video display area 38a on the 2D/3D simultaneous display screen 38 and the 3D video is displayed in the second video display area 38b, but the present invention is not limited thereto, and the 3D video may be displayed in the first video display area 38a and the 2D video may be displayed in the second video display area 38b. In other words, the first and second video display areas 38a and 38b are not particularly limited in their size and display position as long as they do not overlap each other.

The shutter control signals indicating the right-eye video display period and the left-eye video display period of the video signal for 3D display, respectively, are transmitted to the stereoscopic viewing glasses 20, 21 by the infrared emitter 19 with an infrared ray as a transmission medium in the embodiment, but the present invention is not limited thereto, and the shutter control signals may be wirelessly transmitted to the stereoscopic viewing glasses 20, 21 with a radio signal as a transmission medium or the shutter control signals may be transmitted to the stereoscopic viewing glasses 20, 21 by wire.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A video displaying apparatus comprising:
a separator configured to separate a video signal for 3D video display into a first video signal and a second video signal, separated by a parallax, in units of frame;
a first generator configured to generate a first video frame in which a frame of the first video signal is displayed in a first area on a video display screen;
a second generator configured to generate a second video frame in which a frame of the first video signal or the second video signal is displayed in a second area on the video display screen, the second area being different from the first area;
a third generator configured to generate a third video frame similar to the first video frame;
a fourth generator configured to generate a fourth video frame in which a frame of the first video signal or the second video signal is displayed in the second area on the video display screen, such that the fourth video frame generated in the fourth generator is based on a different video signal than the second video frame generated in the second generator; and
a controller configured to sequentially display the first to fourth video frames on the video display screen.

2. The video displaying apparatus of claim 1, wherein
the first generator is further configured to perform scaling processing and display position control processing on the first video frame,
the second generator is configured to perform the scaling processing and the display position control processing on the second video frame,
the third generator is further configured to perform the scaling processing and the display position control processing on the third video frame, and
the fourth generator is further configured to perform the scaling processing and the display position control processing on the fourth video frame.

3. The video displaying apparatus of claim 1, wherein
the first generator is further configured to perform the scaling processing and the display position control processing on the first video frame and further configured to perform scaling processing on the third video frame,
the second generator is further configured to perform the scaling processing and the display position control processing on the second video frame,
the third generator is further configured to perform the display position control processing on the third video frame, and
the fourth generator is further configured to perform the scaling processing and the display position control processing on the fourth video frame.

4. The video displaying apparatus of claim 1, wherein the first to fourth generators are configured to display in black an area other than the first area or the second area in the first to fourth video frames generated.

5. The video displaying apparatus of claim 1, wherein a display size or a display position of the first area and the second area are configurable, as long as the first and second areas do not overlap each other.

6. The video displaying apparatus of claim 1, further comprising:
a transmitter configured to generate and transmit signals indicating a period in which the first video signal is displayed and a period in which the second video signal is displayed on the video display screen; and
glasses configured to selectively close shutters corresponding to right and left eyes based on the signals transmitted by the transmitter.

7. The video displaying apparatus of claim 1, wherein the first video signal is one of a left-eye video signal and a right-eye video signal and the second video signal is the other of the left-eye video signal and the right-eye video signal.

8. (canceled)

9. A video displaying method comprising:
separating a video signal for 3D video display into a first video signal and a second video signal, separated by a parallax, in units of frame;
generating a first video frame in which a frame of the first video signal is displayed in a first area on a video display screen;
generating a second video frame in which a frame of the first video signal or the second video signal is displayed in a second area on the video display screen, the second area being different from the first area;
generating a third video frame similar to the first video frame;
generating a fourth video frame in which a frame of the first video signal or the second video signal is displayed in the second area on the video display screen, such that the fourth video frame is based on a different video signal than the second video frame; and
sequentially displaying the first to fourth frames on the video display screen.
